(19) United States
(12) Patent Application Publication
(10) Pub. No.: US 2010/0156176 A1
(43) Pub. Date: Jun. 24, 2010

(54) DC POWER SUPPLY DEVICE AND METHOD FOR SUPPLYING MULTIPLE VARIABLE VOLTAGES USING POWER LINE COMMUNICATION

(75) Inventors: Dae Won Kim, Daejeon (KR); Won Ok Kwon, Daejeon (KR); Seong Woon Kim, Gyeryong-si (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/554,544

(22) Filed: Sep. 4, 2009

(30) Foreign Application Priority Data
Dec. 22, 2008 (KR) 10-2008-0131703

(51) Int. Cl. H02J 1/00

(52) U.S. Cl. 307/31

(57) ABSTRACT

Provided are a DC power supply device and a DC power supply system for supplying multiple DC powers having variable voltages using a power line communication (PLC). The DC power supply device includes an AC/DC converter, a DC/DC distributor, a plurality of output voltage regulators, a voltage control module, and a PLC modem. The AC/DC converter converts an inputted AC voltage into DC voltage, and the DC/DC distributor distributes the DC voltage according to number of external devices. The output voltage regulators output the distributed DC voltage to the external devices. The voltage control module controls the output voltage regulators to output voltages according to the voltage request information of the external devices. The PLC modem transmits/receives the real-time voltage request information of the external devices through a power line.

### CROSS-REFERENCE TO RELATED APPLICATIONS

This application claims priority under 35 U.S.C. §119 to Korean Patent Application No. 10-2008-0131703, filed on Dec. 22, 2008, the disclosure of which is incorporated herein by reference in its entirety.

### TECHNICAL FIELD

The present disclosure relates to a DC power supply device for supplying multiple DC powers having variable voltages, and in particular, to a DC power supply device for supplying multiple DC powers having variable voltages and a method for operating the same, which are capable of controlling output voltages according to request of external devices by using a power line communication (PLC).

### BACKGROUND

At present, DC power supply devices are installed inside or outside power dissipation devices in use, and power dissipation device manufacturers separately purchase and use power supply devices for manufacturing the related products. In most cases, when the life span of the product ends, the DC power supply device installed outside the product is discarded together with the product.

In general, DC power supply devices continuously supply constant voltages. Therefore, redundant voltages are applied to the power dissipation devices when a low voltage would be sufficient due to idle mode in which they perform no operations, which causes a great waste of power.

Moreover, AC/DC conversion needs to be performed several times in order to supply certain voltages 220-V AC devices require, and much power loss occurs in the AC/DC conversion. In order for effective power management and power distribution, it is necessary to technically control and supply voltages, and it is also necessary to supply various powers according to power dissipation devices.

### SUMMARY

Accordingly, the present disclosure provides a DC power supply device and method for supplying multiple variable voltages using a PLC, which are capable of supplying voltage levels required by DC devices.

According to an aspect, a DC power supply device for supplying multiple variable voltages includes: an AC/DC converter converting an inputted AC voltage into DC voltage; a DC/DC distributor distributing the DC voltage; a plurality of output voltage regulators receiving the distributed DC voltage to generate output voltages to external devices; a power line communication modem receiving voltage request information of the external devices through a power line; and a voltage control module controlling the output voltage regulators to generate the output voltages corresponding to the voltage request information.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating a DC power supply system for supplying multiple DC powers having variable voltages using a PLC according to an exemplary embodiment;

FIG. 2 is a block diagram illustrating a DC power supply device for supplying multiple DC powers having variable voltages using a PLC according to an exemplary embodiment;

FIG. 3 is a block diagram illustrating a voltage control processor of a voltage control module according to an exemplary embodiment; and

FIG. 4 is a flowchart illustrating a DC power supply method for supplying multiple DC powers having variable voltages using a PLC according to an exemplary embodiment.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout. In this disclosure below, when an element is referred to as being “connected” to another element, it should be understood that the former can be “directly connected or coupled” to the latter, or “electrically connected” to the latter via an intervening element. As used herein, the term “and/or” includes any and all combinations of one or more of the associated listed items. In the following description, the technical terms are used only for explaining a specific exemplary embodiment while not limiting the present invention. The meaning of “include,” “comprise,” “including,” or “comprising,” used herein does not exclude existence or addition of other elements, steps, operations and/or components.

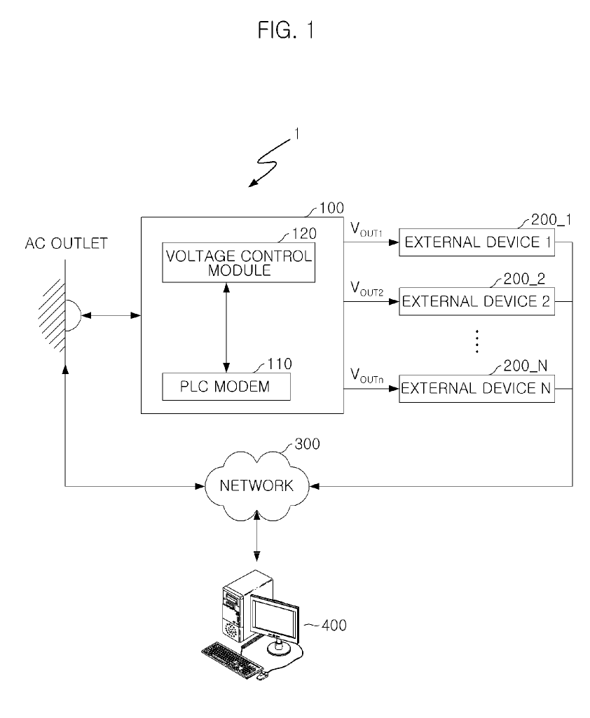

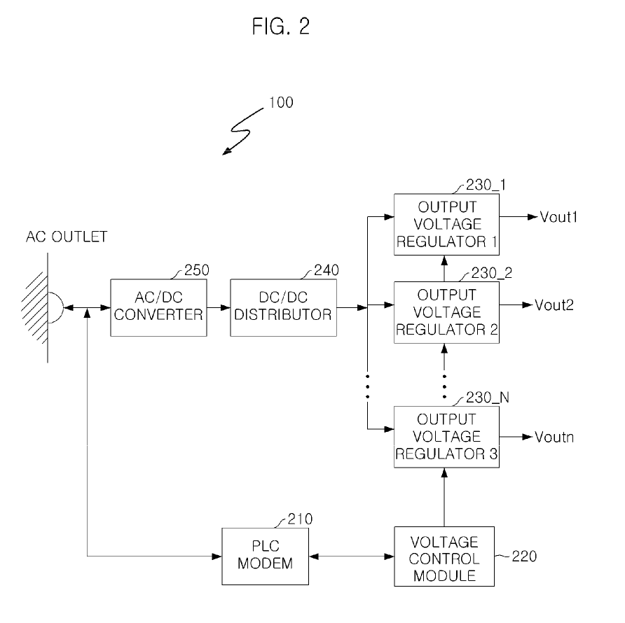

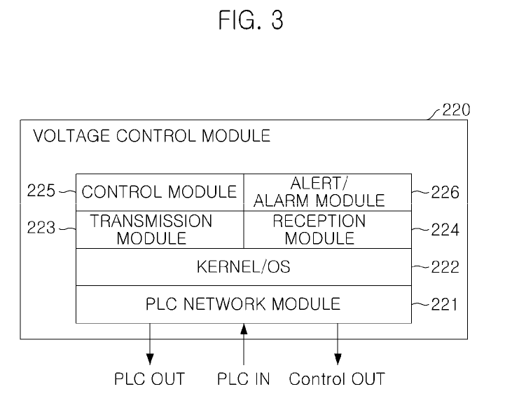

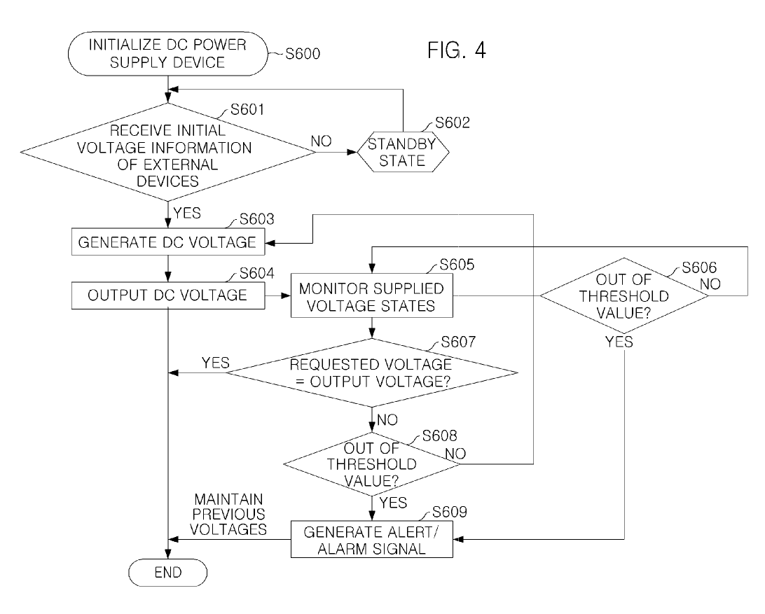

A DC power supply device and method for supplying multiple DC powers having variable voltages using a PLC according to an exemplary embodiment will be described below with reference to FIGS. 1 to 4. FIG. 1 is a block diagram illustrating a DC power supply system for supplying multiple DC powers having variable voltages using a PLC according to an exemplary embodiment. FIG. 2 is a block diagram illustrating a DC power supply device for supplying multiple DC powers having variable voltages using a PLC according to an exemplary embodiment. FIG. 3 is a block diagram illustrating a voltage control processor according to an exemplary embodiment. FIG. 4 is a flowchart illustrating a DC power supply method for supplying multiple DC powers having variable voltages according to an exemplary embodiment.

Referring to FIG. 1, the DC power supply system 1 for supplying multiple DC powers having variable voltages using the PLC according to the exemplary embodiment includes a DC power supply device 100 supplying multiple DC powers having variable voltages, a plurality of external devices 200_1, 200_2, and 200_N supplied with the voltages from the DC power supply device 100, a network 300, a power management device 400, and an AC outlet 500.

The DC power supply device 100 may be supplied with an AC voltage through an AC outlet or multi-tap that is generally installed on a wall at homes or industrial fields. The DC power supply device 100 converts the AC voltage into a DC voltage and supplies the DC voltage to the external devices 200_1, 200_2, and 200_N that are connected to output terminals of the DC power supply device 100. Even though power dissipation devices used at homes or industrial fields are supplied with AC voltages, they are operated with certain DC voltages after AC/DC conversion.

The DC power supply device 100 includes a PLC modem 110 capable of a power line communication, and a voltage control module 120 controlling voltages outputted to the external devices 200_1 to 200_N. The PLC modem 110 receives voltage request information from the external devices 200_1 to 200_N, and transmits the received voltage request information to the voltage control module 120. The voltage control module 120 supplies voltages to the external devices 200_1, 200_2, and 200_N according to the voltage request information. Meanwhile, the PLC modem 110 and the voltage control module 120 monitor the voltages supplied to the external devices 200_1 to 200_N, which will be described later with reference to FIGS. 2 and 3.

The external devices 200_1, 200_2, and 200_N can transmit the voltage request information requesting voltages they need through the network 300 to the PLC modem 110. The external devices 200_1, 200_2, and 200_N may be configured to be controlled by a PLC scheme and to be operated while maintaining stability even though different voltages are supplied if necessary. Examples of the external devices 200_1, 200_2, and 200_N may include household electronic appliances such as washing machines or refrigerators, and IT systems such as laptop computers or desktop PCs.

Furthermore, the external devices 200_1, 200_2, and 200_N may have a smart function that can manage voltage levels and necessary voltages supplied from the outside by themselves using micro CPU mounted therein.

The network 300 may be a cable or wireless communication network that is typically used at home.

The power management device 400 (for example, computer) is connected to the network 300, and can monitor the voltage levels outputted through the DC power supply device 100 to the external devices 200_1 to 200_N, voltage information requested by the external devices 200_1 to 200_N, threshold values, generation of the alarm/alert signals from the DC power supply device 100. The power management device 400 can manually control the voltage control module 120 capable of controlling the voltages outputted to the external devices 200_1 to 200_N, or turn on/off the DC power supply device 100.

Referring to FIG. 2, the DC power supply device 100 for supplying multiple DC powers having variable voltages using the PLC includes an AC/DC converter 250, a DC/DC distributor 240, a plurality of output voltage regulators 230_1, 230_2, and 230_N, a voltage control module 220, and a PLC modem 210.

The AC/DC converter 250 converts an AC input voltage into a DC voltage, and supplies the DC voltage to the DC/DC distributor 240. The DC/DC distributor 240 determines voltages and currents according to the number of the external devices 200_1, 200_2, and 200_N connected to the output terminals of the DC power supply device 100.

The DC/DC distributor 240 distributes the DC voltage to the output voltage regulators 230_1, 230_2, and 230_N.

The output voltage regulators 230_1, 230_2, and 230_N supplies DC voltages required by the external devices 200_1, 200_2, and 200_N among the DC voltages distributed by the DC/DC distributor 240. For example, in case where the external devices 200_1, 200_2, and 200_N need low voltages when they are in idle mode, only some of the DC voltages inputted from the DC/DC distributor 240 are supplied to the external devices 200_1, 200_2, and 200_N.

The voltage control module 220 and the PLC modem 210 transmit/receive the voltage request information of the external devices 200_1, 200_2, and 200_N, and monitor the voltage levels that are supplied through the output voltage regulators 230_1, 230_2, and 230_N to the external devices 200_1, 200_2, and 200_N.

The PLC modem 210 transmits/receives the voltage request information of the external devices 200_1, 200_2, and 200_N. If the external devices 200_1, 200_2, and 200_N transmit the voltage request information, that is, information about the necessary voltage levels, to the PLC modem 210 through the network 300, the PLC modem 210 transmits the received voltage request information to the voltage control module 220.

The voltage control module 220 transmits the received voltage request information to the output voltage regulators 230_1, 230_2, and 230_N connected to the external devices 200_1, 200_2, and 200_N that have transmitted the voltage request information. The voltage request information may be bypassed from the voltage control module 220 to the output voltage regulators 230_1, 230_2, and 230_N, or may be directly transmitted to the output voltage regulators 230_1, 230_2, and 230_N. Meanwhile, the voltage request information is real-time information because the voltages required by the external devices 200_1, 200_2, and 200_N are transmitted to the PLC modem 210 in real time.

When the output voltage levels do not coincide with the voltages required by the external devices 200_1, 200_2, and 200_N, the voltage control module 220 receives new voltage request information of the external devices 200_1, 200_2, and 200_N from the PLC modem 210, and controls the output voltage regulators 230_1, 230_2, and 230_N to output voltages that coincide with the voltages required by the external devices 200_1 and 200_2.

Meanwhile, the PLC modem 210 monitors in real time the voltages outputted to the external devices 200_1, 200_2, and 200_N. Since the monitoring is performed on all the external devices 200_1, 200_2, and 200_N in real time, power consumption of the respective devices can be easily checked. The external devices 200_1, 200_2, and 200_N transmit the voltage levels, which are received from the output voltage regulators 230_1, 230_2, and 230_N, through the network 300 to the PLC modem 210. Then, the PLC modem 210 monitors whether the voltages outputted to the external devices 200_1, 200_2, and 200_N are equal to the voltages required the external devices 200_1, 200_2, and 200_N through the comparison operation of the voltage request information received from the external devices 200_1, 200_2, and 200_N.

Meanwhile, the PLC modem 210 communicates with the AC outlet installed indoor because the PLC modem 210 transmits/receives the voltage request information through the power line. The PLC modem 210 transmits/receives the voltage request information and transmits/receives monitoring information for monitoring the voltages supplied to the external devices 200_1, 200_2, and 200_N.

Like the PLC modem 210, the voltage control module 220 transmits the voltage request information of the external devices 200_1, 200_2, and 200_N and performs the voltage monitoring function. The voltage control module 220 is an embedded microprocessor, which is used as a web server that transmits the received voltage request information to the output voltage regulators 230_1, 230_2, and 230_N and performs the voltage monitoring.

The voltage control module 220 receives the voltage request information from the PLC modem 210, and transmits the received voltage request information to the output voltage regulators 230_1, 230_2, and 230_N connected to the external devices 200_1, 200_2, and 200_N that have transmitted the voltage request information. The output voltage regulators 230_1, 230_2, and 230_N supply the DC voltages distributed from the DC/DC distributor 240 to the external devices 200_1, 200_2, and 200_N under the control of the voltage control module 220.

The voltage control module 220 can control the output voltage regulators 230_1, 230_2, and 230_N so that the DC voltages distributed by the DC/DC distributor 240 are adjusted to the voltages required by the external devices 200_1, 200_2, and 200_N. For example, when the external devices 200_1, 200_2, and 200_N need low voltages when they are in idle mode, such voltage request information is transmitted to the voltage control module 220 through the PLC modem 210. Then, the voltage control module 220 controls the output voltage regulators 230_1, 230_2, and 230_N to output the low voltages requested by the external devices 200_1, 200_2, and 200_N.

In case where the external devices 200_1, 200_2, and 200_N need higher voltages than the current voltages, the voltage control module 220 controls the output voltage regulators 230_1, 230_2, and 230_N to output the high voltages to the external devices 200_1, 200_2, and 200_N through the above-mentioned manner. However, the voltages are adjusted within an upper/lower threshold value range of the voltages that are distributed by the DC/DC distributor 240 to the output voltage regulators 230_1, 230_2, and 230_N.

Meanwhile, the voltage control module 220 monitors the voltages that are outputted to the external devices 200_1, 200_2, and 200_N by the output voltage regulators 230_1, 230_2, and 230_N. For example, the voltage control module 220 monitors in real time whether the voltages required by the external devices 200_1, 200_2, and 200_N are correctly outputted, and whether the output voltages are out of the threshold values of the external devices 200_1, 200_2, and 200_N. A software architecture in which the voltage control module 220 transmits/receives the voltage request information and performs the voltage monitoring will be described below in detail with reference to FIG. 3.

Referring to FIG. 3, the voltage control module 220 includes a PLC network module 221, a Kernel/OS 222, a transmission module 223, a reception module 224, a control module 225, and an alert/alarm module 226.

The control module 225 converts the voltage request information into a voltage control signal. The PLC network module 221 receives the voltage request information from the PLC modem 210, supplies the output voltages to the PLC modem 210, and transmits the voltage control signal to the output voltage regulators 230_1, 230_2, and 230_N. The alert/alarm module 226 generates an alert/alarm signal in a certain case.

The PLC network module 221 is an interface for performing a power line communication with the PLC modem 210. The PLC network module 221 transmits/receives the voltage request information to/from the PLC modem 210, and generates a control signal for controlling the output voltage regulators 230_1, 230_2, and 230_N.

The Kernel/OS 242 is installed on the PLC network module 221, and the transmission module 223 and the reception module 224 for transmission/reception control are installed on the Kernel/OS 222. The transmission module 223 and the reception module 224 are a transmission/reception module of a web server for access to the web for the purpose of voltage monitoring. The web server is provided as a user interface that operates on the Kernel 222.

The control module 225 converts the voltage request information received from the PLC modem 210 into the voltage control signal, and determines which of the transmission module 223 and the reception module 224 will transmit/receive the monitoring information, when intending to transmit/receive the voltage request information.

The alert/alarm module 226 generates an alert/alarm signal in a certain case. For example, in case where the upper/lower threshold values of the voltage levels the external devices 200_1, 200_2, and 200_N can be supplied through the output voltage regulators 230_1, 230_2, and 230_N are previously set, the alert/alarm module 246 generates the alert/alarm signal when the voltage levels outputted from the output voltage regulators 230_1, 230_2, and 230_N are out of the upper/lower threshold values. The alert/alarm module 246 may also generate the alert/alarm signal when the voltages outputted from the output voltage regulators 230_1, 230_2, and 230_N are lower than the voltage levels that are currently required by the external devices 200_1, 200_2, and 200_N, or when the voltages outputted from the output voltage regulators 230_1, 230_2, and 230_N are higher than the voltage levels that are currently required by the external devices 200_1, 200_2, and 200_N, or when the output voltage regulators 230_1, 230_2, and 230_N do not operate normally so that the certain voltage levels are not outputted to the external devices 200_1, 200_2, and 200_N, or when the external devices 200_1, 200_2, and 200_N do not acquire the current voltage request information and the necessary voltage levels from the output voltage regulators 230_1, 230_2, and 230_N.

A DC power supply method for supplying multiple DC powers having variable voltages using a PLC according to an exemplary embodiment will be described below with reference to FIG. 4. Referring to FIG. 4, the DC power supply device is initialized in step S600. The DC power supply device receives initial voltage information of the external devices 200_1, 200_2, and 200_N in step S601 while maintaining a standby state in step S602.

In step S603, the AC voltage supplied through the AC outlet is converted into the DC voltage through the AC/DC converter 250. The DC voltage is inputted to the DC/DC distributor 240, and the DC/DC distributor 240 distributes certain DC voltages to the output voltage regulators 230_1, 230_2, and 230_N according to the number of the external devices 200_1, 200_2, and 200_N.

In step S604, the voltage control module 220 controls the output voltage regulators 230_1, 230_2, and 230_N, based upon the voltage request information of the external devices 200_1, 200_2, and 200_N, and outputs DC voltages required by the external devices 200_1, 200_2, and 200_N.

In step S605, the PLC modem 210 and the voltage control module 220 monitor the supplied voltage states. In step S606, it is determined whether the output voltages are out of the allowable threshold value range of the voltage levels of the external devices 200_1, 200_2, and 200_N. If the output voltages are out of the allowable threshold value range, the voltage control module 220 generates the alert/alarm signal in step S609.

In step S607, it is confirmed whether the voltages requested by the external devices 200_1, 200_2, and 200_N coincide with the output voltages. If the voltages requested by the external devices 200_1, 200_2, and 200_N do not coincide with the output voltages, it is determined whether the output voltages are out of the allowable threshold values of the voltage levels of the external devices 200_1, 200_2, and 200_N, in step S608. If the output voltages are out of the allowable threshold value range, the voltage control module 220 generates the alert/alarm signal in step S609.

When the alert/alarm signal is generated by the voltage control module 220, the voltage control module 220 controls the output voltage regulators 230_1, 230_2, and 230_N to maintain the previous voltage levels.

The alert/alarm signal may be generated when the output voltages from the output voltage regulators 230_1, 230_2, and 230_N are out of the threshold values previously set on the external devices 200_1, 200_2, and 200_N. In addition, the alert/alarm signal may be generated when it is monitored that the output voltages are lower or higher than the voltage levels required by the external devices 200_1, 200_2, and 200_N, or the output voltage regulators 230_1, 230_2, and 230_N do not operate, or the current voltage information of the external devices 200_1, 200_2, and 200_N is not acquired through the PLC modem 210.

Data communication is possible through the power line that has been installed through the infrastructure communication technology of digital home network. LANs for data exchange between PC and various household appliances at the home network may be used, and wireless LANs may be complemented by using the PLC at locations where it is difficult for electric waves to arrive. Furthermore, electronic products such as household appliances, electric heaters, or lighting devices can be controlled by combination with the power line, and communication networks inside buildings such as apartments or offices can be established without installation of network cables. Due to these advantages, the PLC is considered as the most stable communication protocol for control of the home network at the present technological level. Moreover, it is expected that future home network will use the PLC communication as the basic backbone and use the wireless communication such as ZigBee or Bluetooth for communication between devices.

Ethernet adapters, USB adapters, and USB cards embedded in PCs, which are usable if they are simply put into the sockets, have been commercialized and put on the markets. Moreover, it is expected that broadband PLC markets will be gradually expanded all over the world.

According to the embodiments, the power efficiency of the DC power supply system can be increased because voltages are supplied in consideration of power consumption of the external devices connected to the DC power supply device.

In addition, the power supplied to the external devices through the PLC modem can be monitored in real time, and the output voltages can be variably controlled and outputted according to the voltage levels required by the external devices.

Furthermore, the voltage request information required by the external devices can be monitored in real time by using the PLC, without separate network connections.

Moreover, power management and power distribution are efficiently achieved because unnecessary power supply can be prevented by the monitoring and variable control of the output voltages using the PLC.

It should be understood that the present invention can be embodied in various forms by a person with ordinary skill in the art to which this invention pertains, without departing from the technical spirit and essential characteristics thereof. For example, the present invention can be implemented in various forms such as a recording media storing a program for executing the DC power supply method of the present invention. Thus, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A DC power supply device for supplying multiple DC powers having variable voltages, comprising:
an AC/DC converter converting an inputted AC voltage into DC voltage;
a DC/DC distributor distributing the DC voltage;
a plurality of output voltage regulators receiving the distributed DC voltage to generate output voltages to external devices;
a power line communication (PLC) modem receiving voltage request information of the external devices through a power line; and
a voltage control module controlling the output voltage regulators to generate the output voltages according to the voltage request information.

2. The DC power supply device of claim 1, wherein the DC/DC distributor distributes the DC voltage according to number of the external devices.

3. The DC power supply device of claim 1, wherein the PLC modem monitors the voltages that are outputted through the output voltage regulators to the external devices.

4. The DC power supply device of claim 1, wherein, when the voltage levels of the output voltages do not coincide with voltages required by the external devices, the voltage control module receives new voltage request information of the external devices from the PLC modem, and controls the output voltage regulators to output voltages that coincide with the voltages required by the external devices.

5. The DC power supply device of claim 1, wherein the voltage control module monitors the voltages outputted from the output voltage regulators.

6. The DC power supply device of claim 1, wherein the voltage control module comprises:
a control module converting the voltage request information into a voltage control signal; and
a PLC network module receiving the voltage request information from the PLC modem, supplying the output voltages to the PLC modem, and providing the voltage control signal to the output voltage regulators.

7. The DC power supply device of claim 6, wherein the control module transmits monitoring information to the PLC modem so that the PLC modem is enabled to monitor the output voltages.

8. The DC power supply device of claim 6, wherein the voltage control module further comprises an alert/alarm module generating an alert/alarm signal when the output voltages are out of a normal range, or the output voltage regulators do not operate normally, or the voltage control module does not acquire the voltage request information from the PLC modem.

9. The DC power supply device of claim 6, wherein the voltage control module is used as a Kernel-based web server, and the control module and the alert/alarm module are provided as a user interface.

10. The DC power supply device of claim 6, wherein the voltage control module further comprises:
a transmission module monitoring the output voltages and transmitting the monitoring result to the PLC modem; and
a reception module receiving the voltage request information of the external devices from the PLC modem,
wherein the transmission module and the reception module constitute a transmitter and a receiver of a Kernel-based web server, respectively.

11. A DC power supply method for supplying multiple variable voltages, comprising:
converting an inputted AC voltage into DC voltage;
distributing the DC voltage according to number of external devices;
transmitting/receiving voltage request information of the external devices through a power line communication (PLC) modem; and
controlling output voltages according to the voltage request information.

12. The DC power supply method of claim 11, further comprising monitoring the output voltages in real time.

13. The DC power supply method of claim 12, wherein the output voltages are monitored in real time by using the PLC modem and a voltage control module.

14. The DC power supply method of claim 11, wherein the controlling of the output voltages comprises:
converting the voltage request information into a voltage control signal and transmitting the voltage control signal to output voltage regulators; and
generating an alert/alarm signal according to states of the output voltage regulators.

15. The DC power supply method of claim 11, wherein, when voltage levels supplied from output voltage regulators do not coincide with voltages required by the external devices, the output voltages are controlled to coincide with voltage levels required by the external devices.

16. The DC power supply method of claim 14, wherein the alert/alarm signal is generated when voltage levels outputted from output voltage regulators are out of a normal range, or the output voltage regulators do not operate normally, or the voltage request information is not acquired from the PLC modem.

17. A DC power supply system for supplying multiple DC powers having variable voltages, comprising:
a plurality of external devices outputting voltage request information;
an AC outlet providing an AC voltage and the voltage request information transmitted through a network;
a DC power supply device converting the AC voltage into DC voltage corresponding to the voltage request information, and providing the DC voltage to the external devices; and
a power management device connected to the network to monitor the output voltage and control the DC power supply device according to the monitoring result.

18. The DC power supply system of claim 17, wherein the DC power supply device comprises:
a PLC modem receiving the voltage request information from the external devices; and
a voltage control module controlling the output voltage according to the voltage request information provided from the PLC modem.

19. The DC power supply system of claim 18, wherein the PLC modem and the voltage control module monitor the output voltages.
